(19) United States
(12) Patent Application Publication
(10) Pub. No.: US 2024/0367425 A1
(43) Pub. Date: Nov. 7, 2024

(54) FLOORING MATERIAL

(71) Applicant: TOPPAN HOLDINGS INC., Tokyo (JP)

(72) Inventor: Takayuki TSUKAMOTO, Tokyo (JP)

(73) Assignee: TOPPAN HOLDINGS INC., Tokyo (JP)

(21) Appl. No.: 18/774,658

(22) Filed: Jul. 16, 2024

Related U.S. Application Data
(63) Continuation of application No. PCT/JP2023/001170, filed on Jan. 17, 2023.

(30) Foreign Application Priority Data
Jan. 21, 2022 (JP) 2022-007940

(51) Int. Cl. B32B 27/20; B32B 5/18; B32B 7/12; B32B 27/06; B32B 27/30; B32B 27/32; E04F 15/10; E04F 15/22

(52) U.S. Cl. CPC B32B 27/20; B32B 5/18; B32B 27/065; B32B 27/304; B32B 27/32; E04F 15/107; E04F 15/225; B32B 7/12; B32B 2266/025; B32B 2305/30; B32B 2307/536; B32B 2307/546; B32B 2307/7376; B32B 2471/00

(57) ABSTRACT

A flooring material includes: a flooring upper material; a flooring base material disposed under the flooring upper material and formed of a soft material; and an intermediate material disposed between the flooring upper material and the flooring base material, the intermediate material is formed of a thermoplastic resin containing 40 mass % or more and 85 mass % or less of calcium carbonate, the intermediate material has a thickness of 3 mm or more and 5 mm or less, the intermediate material has a bending rigidity per unit width of 15 Nm² or more and 90 Nm² or less, the flooring base material has a thickness of 4 mm or more and 15 mm or less, and the flooring base material has an Asker C hardness of 20 or more and 60 or less.

### CROSS-REFERENCE TO RELATED PATENT APPLICATIONS

This application is a continuation application filed under 35 U.S.C. § 111 (a) claiming the benefit under 35 U.S.C. §§ 120 and 365 (c) of International Patent Application No. PCT/JP2023/001170, filed on Jan. 17, 2023, which is based upon and claims the benefit to Japanese Patent Application No. 2022-007940 filed on Jan. 21, 2022, the disclosures of all which are incorporated herein by reference in their entirety.

### Technical Field

The present disclosure relates to a flooring material, particularly relates to a flooring material capable of reducing the risk of fracture caused by a fall or the like.

### BACKGROUND

### Background Art

Fall-related fractures in elderly people have become a social issue recently, accounting for 10% of the causes of elderly people becoming in need of care. The fall-related fracture site is greatly different depending on the age of the person, and people in their 60s or older have an increased risk of femoral fracture. Femoral fracture requires hospital treatment resulting in the person being unable to walk for a long period, therefore leading to decrease in bone mass, which tends to aggravate symptoms, leading to a requirement for nursing care. Fall-related fracture accounts for 20% to 25% of medical accidents, and accounts for 20% or more of all accidents in nursery-related facilities such as preschools, nursery schools, and authorized kindergartens. Under these circumstances, a flooring material has been proposed that reduces the risk of fracture by absorbing the shock of a fall (for example, Patent Literatures 1 and 2). Many of such flooring materials include a soft layer obtained by, for example, foaming the flooring material itself, or stacking a foam resin sheet, as a base, for shock absorption on the rear side of the flooring material, and are thereby provided with a function of absorbing shock.
[Citation List] [Patent Literatures] [PTL 1] JP 3600726 B; [PTL 2] JP 5244927 B.

### SUMMARY OF THE INVENTION

### Technical Problems

However, the use of this flooring material as a flooring material in facilities such as a hospital tends to cause a problem with load bearing because the flooring material is easily deformed when subjected to a load by, for example, placing a heavy object, such as a bed, on the flooring material, or moving, on the flooring material, a heavy object with wheels attached. The flooring material may also be excessively deformed at the location of a fall at the time of a fall and cannot sometimes give sufficient shock absorbency.

The present disclosure has been made in view of these problems, and an object of the present disclosure is to provide a flooring material having excellent load bearing and shock absorbency.

### Solution to Problems

In order to solve the problems, a flooring material according to one aspect of the present disclosure includes: a flooring upper material; a flooring base material disposed under the flooring upper material and formed of a soft material; and an intermediate material disposed between the flooring upper material and the flooring base material, the intermediate material is formed of a thermoplastic resin containing 40 mass % or more and 85 mass % or less of calcium carbonate, the intermediate material has a thickness of 3 mm or more and 5 mm or less, the intermediate material has a bending rigidity per unit width of 15 Nm² or more and 90 Nm² or less, the flooring base material has a thickness of 4 mm or more and 15 mm or less, and the flooring base material has an Asker C hardness of 20 or more and 60 or less.

### Advantageous Effects of the Invention

The present disclosure can provide a flooring material having excellent load bearing and shock absorbency.

### BRIEF DESCRIPTION OF THE DRAWINGS

FIG. 1 is a cross-sectional view illustrating an example of positional configuration of a flooring material according to the present disclosure.

FIG. 2 is a schematic view for illustrating a shock load measuring device used in an evaluation of a shock-absorbing flooring material.

### DETAILED DESCRIPTION

### Description of the Embodiments

Hereinafter, embodiments of the present invention are described with reference to the drawings. The embodiments described below, however, exemplify a device and a method for embodying a technical idea of the present technique. The technical idea of the present technique can be modified variously within the technical scope set forth in the claims.

<Basic configuration of flooring material>

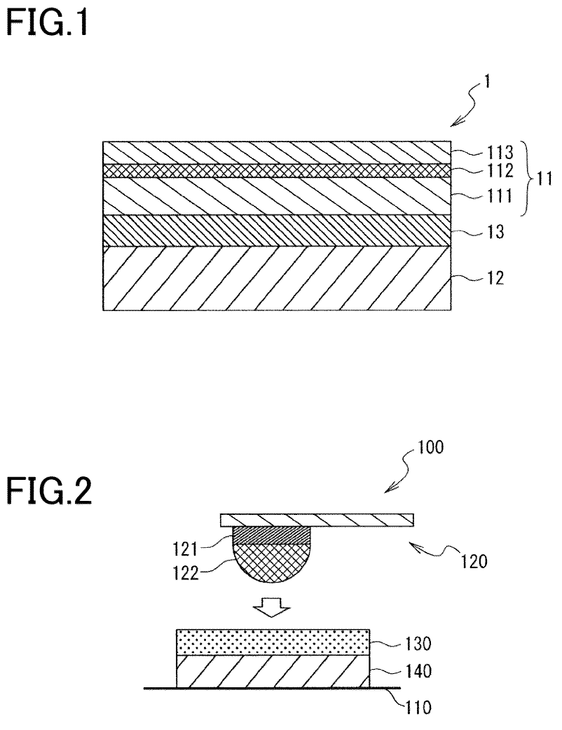

Hereinafter, a flooring material according to the present disclosure (hereinafter, referred to as a flooring material) 1 is described with reference to FIG. 1.

The flooring material 1 includes: a flooring upper material 11; a flooring base material 12 disposed under (on an attachment surface of the flooring material 1) the flooring upper material 11; and an intermediate material 13 disposed between the flooring upper material 11 and the flooring base material 12. The flooring material 1 has a function of suppressing femoral fracture caused by the shock of a fall of the user, that is, the person who, for example, walks on the flooring material 1.

The flooring upper material 11 has a surface function of, for example, improving the scratch resistance and the stain resistance of the flooring material 1 and imparting designability to the flooring material 1.

The flooring base material 12 has a function of absorbing the pressure when a user falls, and thus increasing the shock-absorbing properties of the flooring material 1.

The intermediate material 13 has a role of, as a support layer, dispersing the load applied from the flooring upper material 11 to the flooring base material 12, thus improving the shock absorption and load-bearing capacity.

The flooring material 1 is configured to include the flooring upper material 11, the intermediate material 13, and the flooring base material 12 laminated in this order, and thereby can reduce the risk of femoral fracture at the time of a fall while improving the easiness of walking.

The flooring material 1 preferably has a total thickness of more than 7 mm and 22 mm or less.

The flooring material 1 having a total thickness of more than 7 mm allows the walker to easily have a balance between shock absorption, walking feel, and durability. The flooring material 1 having a total thickness of 22 mm or more is likely to cause an installation problem because the difference in level between the part where the flooring material 1 has been installed and the part not installed is excessively large.

<Method of evaluating shock absorbency of flooring material>

A method of evaluating the shock absorbency of the flooring material 1 is described with reference to FIG. 2. The shock absorbency of the flooring material is evaluated according to a “shock load F” obtained by performing a simulated measurement of the shock load applied to a femur during a fall on the flooring material. The shock load F is measured by the method described in JP 2020-76764 A.

As illustrated in FIG. 2, a shock load measuring device 100 includes a measuring stand 110, a shock application member 120, a buffer 130, and a load measuring means 140.

The shock application member 120 includes a weight 121 and a striking part 122. The weight 121 has a mass based on the distribution of pressure applied to a femoral trochanter by a simulated fall, and the striking part 122 is formed in the shape mimicking a femoral trochanter. The buffer 130 is formed of a material mimicking human soft tissue.

The shock load F is obtained by, with an evaluation flooring material 140 (flooring material having the same configuration as the flooring material to be evaluated) placed between the measuring stand 110 and the buffer 130, dropping the shock application member 120 on the buffer 130 from a prescribed height corresponding to the height of the simulated fall, and measuring a maximum value of the load applied to the evaluation flooring material 140 during the drop, using the load measuring means 150.

The flooring material 1 has a shock load F of 2000 N or more and 4000 N or less under the condition (dropping height of the shock application member) of setting a standard shock load Fs to 5600 N, which is generated when a shock is applied only to the buffer without use of the evaluation flooring material in the measuring method. A flooring material 1 having a shock load F of less than 2000 N increases the risk of causing the walker to lose his/her balance and fall while walking on the flooring material 1. A flooring material 1 having a shock load F of more than 4000 N does not sufficiently reduce the risk of fall-related femoral fracture.

Hereinafter, the flooring upper material 11, the flooring base material 12, and the intermediate material 13 are described in detail.

<Flooring upper material>

The flooring upper material 11 is a layer forming the surface of the flooring material 1, and is formed of a harder material than the material of the flooring base material 12.

The flooring upper material 11 preferably has a thickness of 5 mm or less. With the flooring upper material 11 having a thickness of 5 mm or less, the flooring material 1 is not excessively heavy and the burden of installation can be reduced.

The flooring upper material 11 described above may include, as illustrated in FIG. 1, for example, a substrate layer 111, a pattern layer 112, and a protective layer 113. The flooring upper material 11 preferably includes at least the substrate layer 111.

### (Substrate Layer)

The substrate layer 111 may be formed of a wooden substrate such as plywood, a composite substrate obtained by mixing wood powder with plastic, or a hard resin material such as a polyolefin (e.g., polyethylene (PE) and polypropylene (PP)), polyethylene terephthalate (PET), polybutylene terephthalate (PBT), and polyvinyl chloride (PVC). The substrate layer 111 has a function of adjusting the walking feel and the elasticity, and may be disposed, as appropriate, according to the necessity.

(Pattern layer)

The pattern layer 112 is formed on the surface of the substrate layer 111 opposite from the intermediate material 13.

The pattern layer 112 is an ink layer having a pattern, such as wood grain or a geometric pattern, imparted to the substrate layer 111. The pattern layer 112 is a layer for imparting designability to the flooring material 1, and may be disposed, as appropriate, according to requirements.

(Protective layer)

The protective layer 113 is formed on the surface of the pattern layer 112 opposite to that facing the substrate layer 111.

The protective layer 113 is formed of a resin material such as polyethylene (PE), polypropylene (PP), polyethylene terephthalate (PET), polybutylene terephthalate (PBT), polyvinyl chloride (PVC), and an acrylic resin. When the flooring upper material 11 includes the pattern layer 112, the protective layer 113 is formed of a transparent resin material which allows the pattern layer 112 to be seen through the surface of the flooring material 1. The protective layer 113 has a function of protecting the surface so as to improve durability such as chemical resistance, scratch resistance, and dent resistance, and may be provided, as appropriate, according to requirements.

Examples of a method of disposing the flooring upper material 11 described above include a method of stacking the flooring upper material 11 on the intermediate material 13 using, for example, an adhesive, and a method of performing thermal lamination in an extrusion molding manufacturing process of the intermediate material 13.

<Flooring base material>

The flooring base material 12 is disposed under the flooring upper material 11 (on the opposite side to the front surface of the flooring upper material 11). The flooring base material 12 has a function of absorbing shock applied to the flooring material 1 by being formed of a softer material than the material of the flooring upper material 11 and by deforming appropriately in the event of a fall. The flooring base material 12 may have a foamed structure, formed such as by independent foaming or continuous foaming, achieved by chemical foaming or physical foaming, or a method such as supercritical foaming.

The flooring base material 12 is preferably formed of a soft thermoplastic resin such as a polyolefin (e.g., polyethylene (PE) and polypropylene (PP)), and a resin (e.g., polyvinyl chloride (PVC), an ethylene-vinyl acetate copolymer (EVA), polystyrene (PS), and polyurethane (PU)).

The flooring base material 12 has an Asker C hardness of 20 or more and 60 or less.

Here, the “Asker C” is a measuring device to measure the hardness, i.e., one durometer (spring hardness scale) stipulated in SRIS 0101 (Society of Rubber Industry [Japan] Standards). That is, the “Asker C hardness” refers to a value measured by the Asker C hardness scale described above.

A flooring base material 12 having an Asker C hardness of less than 20 is excessively deformed by walking or a fall, and this leads to an increase in the risk of falling and fracture due to deterioration of the walking feel and a decrease of the shock-absorbing effect. The flooring base material 12 having an Asker C hardness of more than 60 is insufficiently deformed and cannot give a sufficient shock-absorbing effect.

The flooring base material 12 has a thickness of 4 mm or more and 15 mm or less. If the thickness of the flooring base material 12 is less than 4 mm, the shock-absorbing effect is insufficient during a fall. If the thickness exceeds 15 mm, not only does the deformation of the flooring material 1 under load increase, thereby reducing its load-bearing capacity, but the risk of falling increases due to increased sinking when walking.

<Intermediate material>

The intermediate material 13 has a function of, as a support layer, dispersing the load applied from the flooring upper material 11 to the flooring base material 12, and thereby improving the shock absorbency and the load bearing of the flooring material 1.

The intermediate material 13 is formed of a thermoplastic resin and contains an inorganic filler. The intermediate material 13 may have a foamed structure, such as that formed by independent foaming or continuous foaming, achieved by chemical foaming or physical foaming, or a method such as supercritical foaming.

The intermediate material 13 preferably contains a thermoplastic resin that is a hard material such as a polyolefin (e.g., polyethylene (PE) and polypropylene (PP)), and a resin base material (e.g., polyvinyl chloride (PVC)), and preferably contains polyvinyl chloride (PVC) from the viewpoint of moldability and general versatility.

The intermediate material 13 contains 40 mass % or more and 85 mass % or less of an inorganic filler.

An intermediate material 13 having an inorganic filler content of less than 40 mass % has insufficient bending rigidity and causes the flooring material 1 to have insufficient shock absorbency. An intermediate material 13 having an inorganic filler content of more than 85 mass % becomes brittle and increases the risk of suffering shock damage during use.

Examples of the inorganic filler that can be used include talc, silica, calcium carbonate, barium sulfate, aluminum hydroxide, carbon fibers, and glass fibers, and calcium carbonate is preferable as a versatile material having excellent processability.

The intermediate material 13 has a bending rigidity per unit width of 15 Nm² or more and 90 Nm² or less.

An intermediate material 13 having a bending rigidity per unit width of less than 15 Nm² suffers a large distortion in response to a local shock during a fall, and thus cannot disperse load and give sufficient shock absorbency. An intermediate material 13 having a bending rigidity per unit width of greater than 90 Nm² does not distort sufficiently during a shock, and thus is also likely to have insufficient shock absorbency.

The intermediate material 13 has a thickness of 3 mm or more and 5 mm or less.

An intermediate material 13 having a thickness of less than 3 mm suffers a large distortion in response to a local shock during a fall, and thus cannot give a sufficient shock-dispersing effect. An intermediate material 13 having a thickness of greater than 5 mm has insufficient deflection, and thus cannot give a sufficient shock-dispersing effect. In both the cases, the flooring material 1 is likely to have an insufficient shock-absorbing effect.

<Effects of Flooring Material According to the Present Disclosure>

The flooring material according to the present disclosure described above have the following effects.

(1) A flooring material according to the present disclosure includes: a flooring upper material; a flooring base material disposed under the flooring upper material and formed of a soft material; and an intermediate material disposed between the flooring upper material and the flooring base material, the intermediate material is formed of a thermoplastic resin containing 40 mass % or more and 85 mass % or less of an inorganic filler, the intermediate material has a thickness of 3 mm or more and 5 mm or less, the intermediate material has a bending rigidity per unit width of 15 Nm² or more and 90 Nm² or less, the flooring base material has a thickness of 4 mm or more and 15 mm or less, and the flooring base material has an Asker C hardness of 20 or more and 60 or less.

Due to these features, the flooring material has excellent load bearing and shock absorbency.

(2) In the flooring material according to the present disclosure, the inorganic filler may contain calcium carbonate.

Since calcium carbonate is highly versatile and has excellent processability, the flooring material becomes easy to manufacture.

(3) The flooring material according to the present disclosure preferably has, under a condition of setting a standard shock load Fs to 5600 N, a shock load F of 2000 N or more and 4000 N or less, the standard shock load Fs being generated when a shock is applied to a buffer by dropping a shock application member from a prescribed dropping height, the buffer being formed of a material mimicking a human soft tissue, the shock application member having a weight and a shape based on a distribution of pressure applied to a femoral trochanter of a user having fallen, and the prescribed dropping height corresponding to a height of a waist of the user; and the shock load F being generated when a shock is applied to the flooring material via the buffer by dropping the shock application member from the prescribed drop height.

This setting lowers the risk of loss of balance and falling while walking, and the risk of fall-related femoral fracture is sufficiently reduced for people walking on it.

### EXAMPLES

Hereinafter, the flooring material according to the present disclosure is described by way of examples. The flooring material according to the present disclosure, however, is not limited to these examples.

### Example 1

A flooring material according to Example 1 was formed by laminating, using an adhesive, an intermediate material (polyvinyl chloride resin plate, content ratio of calcium carbonate: 80 mass %, dimension: 600 mm×600 mm×thickness 3 mm, bending rigidity: 20 Nm²) and a flooring upper material (polyvinyl chloride resin sheet, dimension: 600 mm×600 mm ×thickness 2 mm) on a flooring base material (polyethylene resin foam, dimension: 600 mm×600 mm×thickness 7 mm, Asker C hardness: 40).

### Example 2

A flooring material according to Example 2 was formed in the same manner as in Example 1 except for changing the thickness of the intermediate material to 4 mm and the bending rigidity to 40 Nm².

### Example 3

A flooring material according to Example 3 was formed in the same manner as in Example 2 except for changing the thickness of the flooring base material to 5 mm.

### Example 4

A flooring material according to Example 4 was formed in the same manner as in Example 2 except for replacing calcium carbonate as the inorganic filler in the intermediate material, with barium sulfate.

### Example 5

A flooring material according to Example 5 was formed in the same manner as in Example 4 except for changing the content of barium sulfate in the intermediate material to 85% and the bending rigidity of the intermediate material to 50 Nm².

### Example 6

A flooring material according to Example 6 was formed in the same manner as in Example 1 except for changing the thickness of the intermediate material to 5 mm and the bending rigidity to 85 Nm².

### Example 7

A flooring material according to Example 7 was formed in the same manner as in Example 2 except for changing the Asker C hardness of the base material to 55.

### Example 8

A flooring material according to Example 8 was formed in the same manner as in Example 2 except for changing the Asker C hardness of the base material to 22.

### Example 9

A flooring material according to Example 9 was formed in the same manner as in Example 2 except for changing the thickness of the base material to 15 mm.

### Example 10

A flooring material according to Example 10 was formed in the same manner as in Example 2 except for changing the content of calcium carbonate in the intermediate material to 45% and the bending rigidity to 15 Nm².

### Comparative Example 1

A flooring material according to Comparative Example 1 was formed in the same manner as in Example 2 except for changing the thickness of the intermediate material to 2 mm and the bending rigidity to 5 Nm².

### Comparative Example 2

A flooring material according to Comparative Example 2 was formed in the same manner as in Example 2 except for changing the thickness of the intermediate material to 6 mm and the bending rigidity to 140 Nm².

### Comparative Example 3

A flooring material according to Comparative Example 3 was formed in the same manner as in Example 4 except for changing the content of barium sulfate in the intermediate material to 87% and the bending rigidity to 55 Nm².

### Comparative Example 4

A flooring material according to Comparative Example 4 was formed in the same manner as in Example 2 except for replacing calcium carbonate as the inorganic filler in the intermediate material, with barium sulfate, and changing the content of barium sulfate to 35% and the bending rigidity to 10 Nm².

### Comparative Example 5

A flooring material according to Comparative Example 5 was formed in the same manner as in Example 2 except for changing the Asker C hardness of the base material to 65.

### Comparative Example 6

A flooring material according to Comparative Example 6 was formed in the same manner as in Example 2 except for changing the Asker C hardness of the base material to 18.

### Comparative Example 7

A flooring material according to Comparative Example 7 was formed in the same manner as in Example 2 except for changing the thickness of the flooring base material to 3 mm.

### Comparative Example 8

A flooring material according to Comparative Example 8 was formed in the same manner as in Example 2 except for changing the thickness of the flooring base material to 20 mm.

[Evaluation]

(Shock absorbency)

The flooring materials according to the examples and comparative examples were each cut into a 100-mm square as a test piece, and the shock load F was measured by a method described in JP 2020-076764 A.
Measurement conditions
   Load cell: “TCLU-5A” manufactured by Tokyo Measuring Instruments Laboratory Co., Ltd.
   Radius of curvature R of striking part: 100 mm
   Mass of shock application member: 5.85 kg.
   Drop height of shock application member: 50 cm
   Buffer: “Hitohada Gel” manufactured by EXSEAL CO., LTD., 20-mm thickness, Asker C hardness: 7
Evaluation criteria.
   2000 N≤ Fs≤3400 N: Good (Pass).
   3400 N<Fs≤4000 N: Fair (Pass).
   4000 N<Fs: Poor (Fail)

(Load bearing)

The flooring materials according to the examples and comparative examples were each cut into a 300 mm×600 mm rectangular piece, and two cut pieces were prepared for each of the flooring materials and bonded onto a calcium silicate board (600 mm×600 mm, thickness: 12 mm) next to each other to form a test piece. Load bearing was evaluated according to the appearance of the flooring material and the intermediate material after the test piece underwent a caster test. The conditions for the caster test were as follows.
Conditions for caster test: steel wheel (diameter: 100 mm, width: 30 mm), load: 100 kgf, 500 runs in the vertical direction to the boundary of the two pieces of the flooring material
Evaluation criteria
   Little to no appearance change of the flooring material and the intermediate material: Good (Pass)
   Moderate appearance change observed in the flooring material or the intermediate material: Fair (Pass)
   Considerable appearance change observed in the flooring material or the intermediate material: x (Fail)

Table 1 below shows the evaluation results of the examples and the comparative examples.

TABLE 1

| | Flooring base | | Intermediate material | | | | | | |
|---|---|---|---|---|---|---|---|---|---|
| | material | | | | Content of | Bending | Evaluation | | |
| | Thickness | Asker C | Thickness | Inorganic | inorganic | rigidity | Shock | Shock | Load |
| | [mm] | hardness | [mm] | filler material | filler [wt %] | [Nm²] | load [N] | absorbency | bearing |
| Example 1 | 7 | 40 | 3 | Calcium | 80 | 20 | 3500 | Fair | Fair |
| | | | | carbonate | | | | | |
| Example 2 | 7 | 40 | 4 | Calcium | 80 | 40 | 3100 | Good | Good |
| | | | | carbonate | | | | | |
| Example 3 | 5 | 40 | 4 | Calcium | 80 | 40 | 3800 | Fair | Good |
| | | | | carbonate | | | | | |
| Example 4 | 7 | 40 | 4 | Barium | 80 | 40 | 3100 | Good | Good |
| | | | | sulfate | | | | | |
| Example 5 | 7 | 40 | 4 | Barium | 85 | 50 | 3200 | Good | Fair |
| | | | | sulfate | | | | | |
| Example 6 | 7 | 40 | 5 | Calcium | 80 | 85 | 3800 | Fair | Good |
| | | | | carbonate | | | | | |
| Example 7 | 7 | 55 | 4 | Calcium | 80 | 40 | 3500 | Fair | Good |
| | | | | carbonate | | | | | |
| Example 8 | 7 | 22 | 4 | Calcium | 80 | 40 | 3500 | Fair | Fair |
| | | | | carbonate | | | | | |
| Example 9 | 15 | 40 | 4 | Calcium | 80 | 40 | 2500 | Good | Fair |
| | | | | carbonate | | | | | |
| Example 10 | 7 | 40 | 4 | Calcium | 45 | 15 | 3800 | Fair | Fair |
| | | | | carbonate | | | | | |
| Comparative | 7 | 40 | 2 | Calcium | 80 | 5 | 4200 | Poor | Fair |
| Example 1 | | | | carbonate | | | | | |
| Comparative | 7 | 40 | 6 | Calcium | 80 | 140 | 4200 | Poor | Good |
| Example 2 | | | | carbonate | | | | | |
| Comparative | 7 | 40 | 4 | Barium | 87 | 55 | 3300 | Good | Poor |
| Example 3 | | | | sulfate | | | | | |
| Comparative | 7 | 40 | 4 | Calcium | 35 | 10 | 4100 | Poor | Good |
| Example 4 | | | | carbonate | | | | | |
| Comparative | 7 | 65 | 4 | Calcium | 80 | 40 | 4500 | Poor | Good |
| Example 5 | | | | carbonate | | | | | |
| Comparative | 7 | 18 | 4 | Calcium | 80 | 40 | 4500 | Poor | Fair |
| Example 6 | | | | carbonate | | | | | |
| Comparative | 3 | 40 | 4 | Calcium | 80 | 40 | 4500 | Poor | Good |
| Example 7 | | | | carbonate | | | | | |
| Comparative | 20 | 40 | 4 | Calcium | 80 | 40 | 2500 | Good | Poor |
| Example 8 | | | | carbonate | | | | | |

As shown in Table 1, all the flooring materials according to the examples had good results in both shock absorbency and load bearing since they included a flooring upper material, a flooring base material, and an intermediate material, the intermediate material had a content of an inorganic filler of 40 mass % or more and 85 mass % or less, the intermediate material had a thickness of 3 mm or more and 5 mm or less and a bending rigidity per unit width of 15 Nm² or more and 90 Nm² or less, and the flooring base material had a thickness of 4 mm or more and 15 mm or less and an Asker C hardness of 20 or more and less than 60.

On the other hand, the flooring material according to Comparative Example 1 that included an intermediate material having a thickness of less than 3 mm, and the flooring material according to Comparative Example 2 that included an intermediate material having a thickness of more than 5 mm had lower shock absorbency.

The flooring material according to Comparative Example 3 that included an intermediate material having a content of an inorganic filler of more than 85 mass % had sufficient shock absorbency but insufficient load bearing. The flooring material according to Comparative Example 4 that included an intermediate material having a content of an inorganic filler of less than 40 mass % had sufficient load bearing but insufficient shock-absorption capacity.

The flooring material according to Comparative Example 5 that included a flooring base material having an Asker C hardness of greater than 60, and the flooring material according to Comparative Example 6 that included a flooring base material having an Asker C hardness of less than 20 both had insufficient shock absorbency.

The flooring material according to Comparative Example 7 that included a flooring base material having a thickness of less than 4 mm had insufficient shock absorbency. On the other hand, the flooring material according to Comparative Example 8 that included a flooring base material having a thickness of more than 15 mm had sufficient shock absorbency but insufficient load bearing.

As is understood from the above, the flooring material according to the present disclosure has excellent load bearing and shock absorbency due to the features in which the intermediate material is formed of a thermoplastic resin containing 40 mass % or more and 85 mass % or less of calcium carbonate, the intermediate material has a thickness of 3 mm or more and 5 mm or less, the intermediate material has a bending rigidity per unit width of 15 Nm² or more and 90 Nm² or less, the flooring base material has a thickness of 4 mm or more and 15 mm or less, and the flooring base material has an Asker C hardness of 20 or more and 60 or less.

The embodiments of the present disclosure have been described above. The embodiments, however, merely exemplify a device and a method for embodying a technical idea of the present disclosure, and the technical idea of the present disclosure is not intended to limit the material, shape, structure, layout and the like of the components. The technical idea of the present disclosure can be modified variously within the technical scope stipulated in the claims of CLAIMS.

[Reference Signs List] 1 . . . . Flooring material; 11 . . . . Flooring material; 111 . . . . Substrate layer; 112 . . . . Pattern layer; 113 . . . . Protective layer; 12 . . . . Flooring base material; 13 . . . . Flooring intermediate material; 100 . . . . Shock load measuring device; 110 . . . . Measuring stand; 120 . . . . Shock application member; 121 . . . . Weight; 122 . . . . Striking part; 130 . . . . Buffer; 140 . . . . Load measuring means.

What is claimed is:

1. A flooring material, comprising:
a flooring upper material;
a flooring base material disposed under the flooring upper material and formed of a soft material; and
an intermediate material disposed between the flooring upper material and the flooring base material, wherein
the intermediate material is formed of a thermoplastic resin containing 40 mass % or more and 85 mass % or less of an inorganic filler,
the intermediate material has a thickness of 3 mm or more and 5 mm or less,
the intermediate material has a bending rigidity per unit width of 15 Nm² or more and 90 Nm² or less,
the flooring base material has a thickness of 4 mm or more and 15 mm or less, and
the flooring base material has an Asker C hardness of 20 or more and 60 or less.

2. The flooring material of claim 1, wherein
the inorganic filler contains calcium carbonate.

3. The flooring material of claim 1, wherein
the flooring material having, under a condition of setting a standard shock load Fs to 5600 N, a shock load F of 2000 N or more and 4000 N or less, the standard shock load Fs being generated when a shock is applied to a buffer by dropping a shock application member from a prescribed drop height, the buffer being formed of a material mimicking human soft tissue, the shock application member having a weight and a shape based on a distribution of pressure applied to a femoral trochanter of a user having fallen, and the prescribed drop height corresponding to a height of a waist of the user; and the shock load F being generated when a shock is applied to the flooring material via the buffer by dropping the shock application member from the prescribed drop height.
